(19) United States
(12) Patent Application Publication
(10) Pub. No.: US 2020/0309020 A1
(43) Pub. Date: Oct. 1, 2020

(54) IN-CYLINDER INJECTION ENGINE

(71) Applicant: HONDA MOTOR CO., LTD., Tokyo (JP)

(72) Inventors: Masafumi TAKI, Wako-shi (JP); Yusuke MARUI, Wako-shi (JP); Hiroya UEDA, Wako-shi (JP)

(73) Assignee: HONDA MOTOR CO., LTD., Tokyo (JP)

(21) Appl. No.: 16/829,983

(22) Filed: Mar. 25, 2020

(30) Foreign Application Priority Data
Mar. 29, 2019 (JP) 2019-067737

(51) Int. Cl. F02B 23/10; F02F 3/26; F02B 17/00

(52) U.S. Cl. CPC F02B 23/104; F02F 3/26; F02B 17/005; F02F 2001/245; F02B 2275/48; F02B 2023/106; F02B 2275/18

(57) ABSTRACT

An in-cylinder injection engine includes: a cylinder head that includes a gasket surface stacked on a seating face of a cylinder block and defines a combustion chamber between a piston and a ceiling surface gradually receding from an imaginary plane including the gasket surface in going toward a center of the cylinder head; two intake ports disposed side by side and opened in the ceiling surface of the cylinder head; and a fuel injection valve mounted to the cylinder head and having an injection port facing the combustion chamber at a position between an opening of the intake port and the gasket surface. The intake port is formed to have a shape of introducing an airflow laterally into the combustion chamber along the imaginary plane. Accordingly, the in-cylinder injection engine can reduce attachment of injected fuel to a wall surface of a cylinder bore.

### CROSS REFERENCE TO RELATED APPLICATIONS

The present application claims priority under 35 U.S.C. § 119 to Japanese Patent Application No. 2019-67737 filed Mar. 29, 2019 the entire contents of which are hereby incorporated by reference.

### BACKGROUND OF THE INVENTION

### Field of the Invention

The present invention relates to an in-cylinder injection engine comprising: a cylinder block that defines a cylinder bore and includes a seating face, the cylinder bore guiding linear reciprocation motions of a piston, the seating face surrounding an opening of the cylinder bore; a cylinder head that includes a gasket surface stacked on the seating face of the cylinder block and defines a combustion chamber between the piston and a ceiling surface gradually receding from an imaginary plane including the gasket surface in going toward a center of the cylinder head; two intake ports disposed side by side and opened in the ceiling surface of the cylinder head; two exhaust ports disposed side by side and opened in the ceiling surface of the cylinder head; and a fuel injection valve mounted to the cylinder head and having an injection port facing the combustion chamber at a position between an opening of the intake port and the gasket surface.

### Description of the Related Art

Japanese Patent No. 4004176 discloses a gasoline direct injection engine (in-cylinder injection engine). The gasoline direct injection engine includes a cylinder head that is stacked on a cylinder block at its gasket surface and defines a combustion chamber between the cylinder head and a piston. In the cylinder head, a ceiling surface that gradually recedes from an imaginary plane including the gasket surface in going toward the center covers a combustion chamber.

In the ceiling surface of the cylinder head, two intake ports are disposed side by side and opened. To an opening of the intake port, an annular valve seat that receives an intake valve is fixed. In the cylinder head, an intake passage is formed to stand from the valve seat, parallel to a center axis of the valve seat. The intake passage is curved to bulge upwardly.

To the cylinder head, a fuel injection valve that injects fuel toward the combustion chamber from an injection port is mounted. The injection port of the fuel injection valve faces the combustion chamber at a position between the opening of the intake port and the gasket surface. When the piston moves down inside a cylinder bore, air is introduced into the combustion chamber from the intake port. The air flows in a longitudinal direction inside the combustion chamber in a direction intersecting with the imaginary plane including the gasket surface. Inside the combustion chamber, a tumble flow is generated within only a limited range below the intake port. The injected fuel passes through an airflow and is easily attached to a wall surface of the cylinder bore.

### SUMMARY OF THE INVENTION

The present invention has been made in consideration of the above-described actual situation, and an object of the present invention is to provide an in-cylinder injection engine that ensures reducing attachment of injected fuel to the wall surface of the cylinder bore. In order to achieve the object, according to a first aspect of the present invention, an in-cylinder injection engine comprising: a cylinder block that defines a cylinder bore and includes a seating face, the cylinder bore guiding linear reciprocation motions of a piston, the seating face surrounding an opening of the cylinder bore; a cylinder head that includes a gasket surface stacked on the seating face of the cylinder block and defines a combustion chamber between the piston and a ceiling surface gradually receding from an imaginary plane including the gasket surface in going toward a center of the cylinder head; two intake ports disposed side by side and opened in the ceiling surface of the cylinder head; two exhaust ports disposed side by side and opened in the ceiling surface of the cylinder head; and a fuel injection valve mounted to the cylinder head and having an injection port facing the combustion chamber at a position between an opening of the intake port and the gasket surface, wherein the intake port is formed to have a shape of introducing an airflow laterally into the combustion chamber along the imaginary plane.

With the first aspect, when the piston moves down inside the cylinder bore, air is introduced into the combustion chamber from the intake port. The fuel is injected to a flowing air from the fuel injection valve. At this time, since the air is laterally introduced into the combustion chamber, a tumble flow (whirl in a longitudinal direction) is formed inside the combustion chamber. The injected fuel is properly caught in the tumble flow. Attachment of the injected fuel to a wall surface of the cylinder bore can be reduced. The formation of the tumble flow can contribute to improving a fuel efficiency and the output.

According to a second aspect of the present invention, in addition to the first aspect, the intake port is curved to bulge toward the imaginary plane.

With the second aspect, the intake port is curved to bulge toward the imaginary plane including the gasket surface. Thus, an inertia force is laterally given to the airflow flowing from the intake port into the combustion chamber. The air can properly and laterally flow into the combustion chamber from the intake port. Inside the combustion chamber, the tumble flow can be ensured.

According to a third aspect of the present invention, in addition to the second aspect, the intake port is formed of an intake side valve seat and an intake passage, the intake side valve seat being fixed to the cylinder head in the opening of the intake port and receiving an intake valve, the intake passage being defined in the cylinder head to be connected to the intake side valve seat from a lateral direction along the imaginary plane.

With the third aspect, in the intake port, since the intake passage is laterally connected to the intake side valve seat, the air can properly and laterally flow into the combustion chamber. Inside the combustion chamber, the tumble flow can be properly formed.

According to a fourth aspect of the present invention, in addition to the third aspect, there is provided the in-cylinder injection engine, further comprising an exhaust side valve seat fixed to the cylinder head in an opening of the exhaust port and receiving an exhaust valve, wherein the intake side valve seat is formed to be thinner than the exhaust side valve seat.

With the fourth aspect, the lateral flow is not blocked by the intake side valve seat. The air can properly and laterally flow into the combustion chamber. Inside the combustion chamber, the tumble flow can be properly formed.

According to a fifth aspect of the present invention, in addition to the first aspect, formed in a top surface of the piston are two intake valve recesses opposed to the respective openings of the intake ports, two exhaust valve recesses opposed to the respective openings of the exhaust ports, and one depression expanding across the two intake valve recesses and the two exhaust valve recesses up to an outer periphery area, the one depression being depressed in a spherical surface shape.

With the fifth aspect, the intake valve recesses and the exhaust valve recesses have a function to avoid an interference between the piston, and the intake valve and the exhaust valve at a top dead center. The air flowing from the intake port moves down toward the piston along the wall surface of the cylinder bore on an extension of the intake port to be guided to the depression of the top surface, so as to cross the top surface of the piston. Thus, collision and decay of the tumble flow can be suppressed. Inside the combustion chamber, the tumble flow can be properly formed. The formation of the tumble flow can contribute to improving the fuel efficiency and the output.

According to a sixth aspect of the present invention, in addition to the first aspect, there is provided the in-cylinder injection engine, further comprising a high-pressure fuel pump connected to the fuel injection valve, the high-pressure fuel pump supplying fuel to the fuel injection valve while varying pressure within a predetermined range.

With the sixth aspect, even when a flow speed of the air to be supplied to the engine corresponding to a throttle of a throttle valve is decreased, the pressure supplied from the high-pressure fuel pump to the fuel injection valve corresponding to the decrease of the flow speed can be decreased. Thus, the attachment of the injected fuel to the wall surface of the cylinder bore can be further reduced. The fuel efficiency and the output can be further improved.

According to a seventh aspect of the present invention, in addition to the first aspect, there is provided the in-cylinder injection engine, further comprising an intake valve coupled to a camshaft that is operatively connected with a crankshaft, the intake valve opening and closing the opening of the intake port with respect to the linear reciprocation motions of the piston at a constant opening/closing timing.

With the seventh aspect, since the intake valve ensures the constant opening/closing timing with respect to the linear reciprocation motions of the piston, an inflow amount of the air to the volume of the combustion chamber can be maintained at a determined flow rate. The swirling effect of the tumble flow can be stabilized. The fuel efficiency and the output can be further improved.

According to an eighth aspect of the present invention, in addition to the seventh aspect, there is provided the in-cylinder injection engine, further comprising a fuel pump that includes a drive shaft coaxially coupled to the camshaft and generates pressure corresponding to rotation of the camshaft.

With the eighth aspect, since an operation timing of the fuel pump is involved with the rotation of the camshaft, the fuel injection can be involved with an opening/closing timing of the intake valve. The swirling effect of the tumble flow can be stabilized. The fuel efficiency and the output can be further improved.

According to a ninth aspect of the present invention, in addition to the first aspect, there is provided the in-cylinder injection engine, further comprising an intake valve coupled to a camshaft that is operatively connected with a crankshaft, the intake valve opening and closing the opening of the intake port, wherein the intake port is curved to bulge toward the imaginary plane, and the intake port has a curvature of a lower side contour larger than a curvature of an upper side contour inside an another imaginary plane that passes a center of the opening and is perpendicular to a rotation axis of the camshaft.

With the ninth aspect, since the intake port is curved to bulge toward the imaginary plane including the gasket surface and has the curvature of the lower side contour larger than the curvature of the upper side contour inside the imaginary plane that passes the center of the opening and is perpendicular to the rotation axis of the camshaft, the inertia force is laterally given to the airflow flowing from the intake port into the combustion chamber. The air can properly and laterally flow into the combustion chamber from the intake port. Inside the combustion chamber, the tumble flow can be properly formed. Evaporation of the fuel spray can be promoted.

According to a tenth aspect of the present invention, in addition to the first aspect, there is provided the in-cylinder injection engine, further comprising an intake valve coupled to a camshaft that is operatively connected with a crankshaft, the intake valve opening and closing the opening of the intake port, wherein the intake port is curved to bulge toward the imaginary plane, and an angle between a first intersecting plane and the imaginary plane is configured to be smaller than an angle between a second intersecting plane and the first intersecting plane, the first intersecting plane being parallel to a rotation axis of the camshaft and circumscribed to the intake port from below, the first intersecting plane intersecting with the imaginary plane at a center of the cylinder bore, the second intersecting plane being parallel to the rotation axis of the camshaft and passing a center of an inlet opening of the intake port, and the second intersecting plane intersecting with the imaginary plane at the center of the cylinder bore.

With the tenth aspect, the first intersecting plane specifies a standing angle of the intake port with respect to the imaginary plane including the gasket surface. When the angle of the second intersecting plane with respect to the first intersecting plane is increased, a degree of bending of the intake port is increased. The more increased the degree of bending is, the larger inertia force is laterally given to the airflow flowing from the intake port into the combustion chamber. Inside the combustion chamber, the tumble flow can be properly formed. The evaporation of the fuel spray can be promoted.

According to an eleventh aspect of the present invention, in addition to the first aspect, there is provided the in-cylinder injection engine, further comprising an intake valve coupled to a camshaft that is operatively connected with a crankshaft, the intake valve opening and closing the opening of the intake port, wherein a maximum displaced amount between an intersecting plane and a neutral axis of the intake port is configured to be more than 2 mm, the intersecting plane being parallel to a rotation axis of the camshaft, the intersecting plane passing a center of an inlet opening of the intake port, and the intersecting plane intersecting with the imaginary plane at a center of the cylinder bore.

With the eleventh aspect, the more increased a displaced amount between the intersecting plane and the neutral axis of the intake port is, the more increased the degree of bending of the intake port is. The more increased the degree of bending is, the larger inertia force is laterally given to the airflow flowing from the intake port into the combustion chamber. Inside the combustion chamber, the tumble flow can be properly formed. The evaporation of the fuel spray can be promoted.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 is a side view schematically illustrating an overall configuration of a two-wheeled motor vehicle according to one embodiment.

FIG. 2 is an enlarged vertical sectional view of an internal combustion engine, illustrating a cut surface that is perpendicular to a rotation axis of a crankshaft and includes a cylinder axis.

FIG. 3 is an enlarged vertical sectional view of a cylinder head, illustrating a cut surface that is perpendicular to the rotation axis of the crankshaft and includes axes of an intake valve and an exhaust valve.

FIG. 4 is an enlarged vertical sectional view of the cylinder head and illustrates a cut surface that includes an axis of a camshaft and the axes of the intake valve and the exhaust valve.

FIG. 5 is an enlarged plan view illustrating a gasket surface of the cylinder head.

FIG. 6 is an enlarged plan view illustrating a top surface of a piston.

FIG. 7A is a sectional view taken along the 7A-7A line in FIG. 6 and FIG. 7B is a sectional view taken along the 7B-7B line in FIG. 6.

FIG. 8 is a conceptual diagram schematically illustrating a tumble flow formed inside a combustion chamber.

### DESCRIPTION OF THE PREFERRED EMBODIMENT

The following describes one embodiment of the present invention with reference to the attached drawings. Here, up and down, front and rear, left and right of a vehicle body are specified based on a point of view of an occupant riding on a two-wheeled motor vehicle.

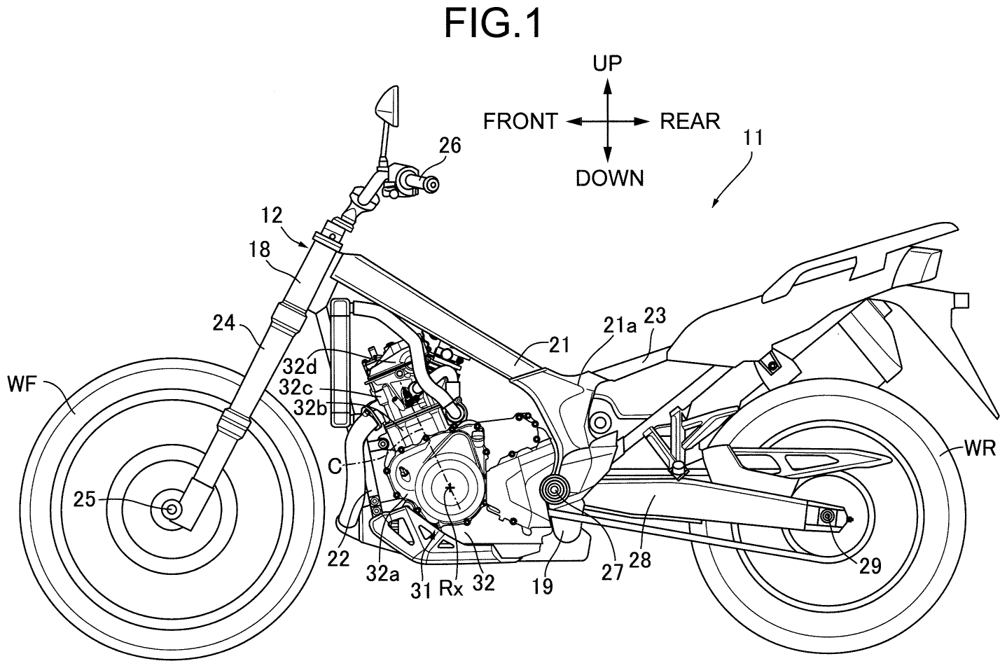

FIG. 1 schematically illustrates a whole image of a two-wheeled motor vehicle as a saddle riding vehicle according to one embodiment of the present invention. A vehicle body frame 12 of the two-wheeled motor vehicle 11 includes a head pipe 18, a pair of left and right main frames 21, a down frame 22, and left and right seat frames 23. The pair of left and right main frames 21 extend obliquely downward to a rear from the head pipe 18 and has a rear lower end that includes a pivot frame 19. The down frame 22 extends downward from the head pipe 18 at a position below the main frames 21 and has a rear lower end joined to the pivot frame 19. The left and right seat frames 23 extend upward to the rear from curved areas 21a of the main frames 21 and constitute a truss structure. The seat frames 23 support an occupant seat.

In the head pipe 18, a front fork 24 is steerably supported. In the front fork 24, a front wheel WF is rotatably supported around an axle 25. The front fork 24 has an upper end to which a steering handle 26 is joined. When a rider drives the two-wheeled motor vehicle 11, the rider holds grips of left and right ends of the steering handle 26.

On the rear of the vehicle, a swing arm 28 is coupled to the vehicle body frame 12 swingably up and downaround a pivot 27. In a rear end of the swing arm 28, a rear wheel WR is rotatably supported around an axle 29. Between the front wheel WF and the rear wheel WR, the vehicle body frame 12 includes an internal combustion engine (in-cylinder injection engine) 31 that generates a power transmitted to the rear wheel WR. The internal combustion engine 31 is coupled and supported to the down frame 22 and the main frames 21. The power of the internal combustion engine 31 is transmitted to the rear wheel WR through a transmission device.

The internal combustion engine 31 includes an engine body 32 that combusts air-fuel mixture inside a combustion chamber to generate the power around a rotation axis Rx. The engine body 32 includes a crankcase 32a, a cylinder block 32b, a cylinder head 32c, and a head cover 32d. The crankcase 32a is supported on the down frame 22 while being coupled to the main frames 21 and outputs the power from a crankshaft around the rotation axis Rx. The cylinder block 32b is joined to a front portion of the crankcase 32a from above and has a cylinder axis C that is positioned within a vertical surface perpendicular to the rotation axis Rx to stand with respect to a horizontal surface. The cylinder head 32c is joined to an upper end of the cylinder block 32b and supports a valve train. The head cover 32d is joined to an upper end of the cylinder head 32c to cover the valve train above the cylinder head 32c.

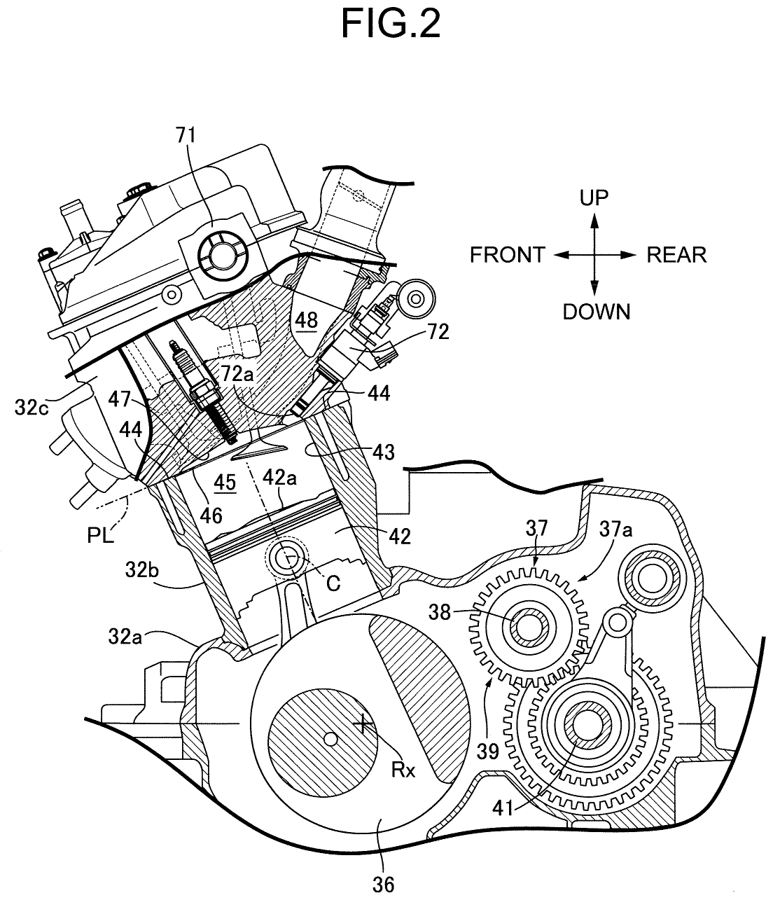

As illustrated in FIG. 2, the engine body 32 includes a power transmission mechanism 37 that takes out the power from the crankshaft 36. The power transmission mechanism 37 includes a multistage transmission 37a that is connected to the crankshaft 36 rotatably supported by the crankcase 32a. The multistage transmission 37a includes a main shaft 38 and a counter shaft 41. The main shaft 38 is connected to the crankshaft 36 via a clutch (not illustrated). The counter shaft 41 is connected to the main shaft 38 via a shift gear 39 that is shiftable to a plurality of shift stages. The power of the crankshaft 36 is transmitted from the counter shaft 41 to the transmission device.

In the cylinder block 32b, a cylinder bore 43 that guides linear reciprocation motions of a piston 42 along the cylinder axis C is defined. The cylinder bore 43 has an opening surrounded by a seating face 44 that receives the cylinder head 32c. The seating face 44 expands within the planar surface perpendicular to the cylinder axis C. The combustion chamber 45 is defined between a top surface 42a of the piston 42 and the cylinder head 32c.

The cylinder head 32c includes a gasket surface 46 stacked on the seating face 44 of the cylinder block 32b. A gasket (not illustrated) is sandwiched between the seating face 44 of the cylinder block 32b and the gasket surface 46 of the cylinder head 32c. In the cylinder head 32c, a ceiling surface 47 that is surrounded by the gasket surface 46 and gradually recedes from an imaginary plane PL including the gasket surface 46 in going toward the center is formed. The combustion chamber 45 is defined between the ceiling surface 47 and the top surface 42a of the piston 42.

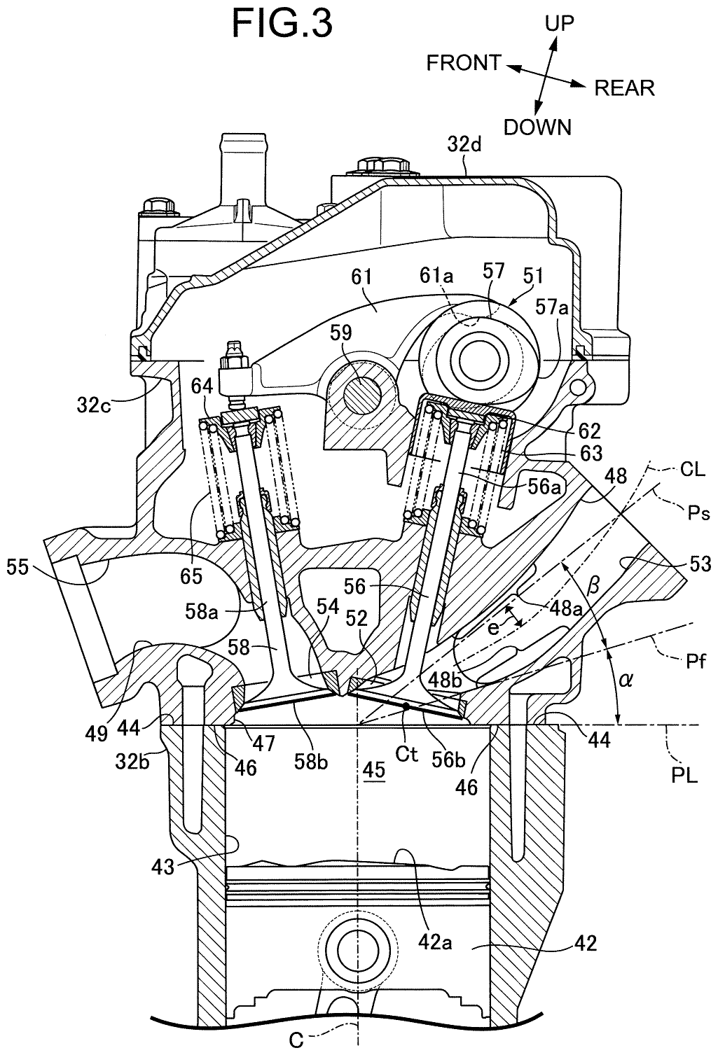

As illustrated in FIG. 3, in the cylinder head 32c, two intake ports 48 and two exhaust ports 49 are formed. The two intake ports 48 are disposed side by side and opened in the ceiling surface 47. The two exhaust ports 49 are disposed side by side and opened in the ceiling surface 47. The intake port 48 is formed to have a shape where an airflow is laterally introduced into the combustion chamber 45 along the imaginary plane PL including the gasket surface 46. The intake port 48 is curved to bulge toward the imaginary plane PL.

The intake port 48 is formed of an intake side valve seat 52 and an intake passage 53. The intake side valve seat 52 is fixed to the cylinder head 32c in an opening of the intake port 48. The intake passage 53 is defined in the cylinder head 32c and connected to the intake side valve seat 52 from a lateral direction along the imaginary plane PL. The exhaust port 49 is formed of an exhaust side valve seat 54 and an exhaust passage 55. The exhaust side valve seat 54 is fixed to the cylinder head 32c in an opening of the exhaust port 49. The exhaust passage 55 is defined in the cylinder head 32c and connected to the exhaust side valve seat 54 from a longitudinal direction intersecting with the imaginary plane PL. The intake side valve seat 52 is formed to be thinner than the exhaust side valve seat 54.

The valve train 51 includes an intake valve 56, a camshaft 57, an exhaust valve 58, and a rocker arm 61. The intake valve 56 is supported displaceably in an axial direction by the cylinder head 32c, faces the combustion chamber 45, and opens and closes the opening of the intake port 48. The camshaft 57 is rotatably supported around an axis by the cylinder head 32c and includes a cam 57a that causes an axial displacement of the intake valve 56. The exhaust valve 58 is supported displaceably in the axial direction by the cylinder head 32c, faces the combustion chamber 45, and opens and closes the opening of the exhaust port 49. The rocker arm 61 is swingably supported by a rocker arm shaft 59, swings around the rocker arm shaft 59 corresponding to a shape of the cam 57a of the camshaft 57, and causes an axial displacement of the exhaust valve 58.

The intake valve 56 includes a valve stem 56a and a valve head 56b. The valve stem 56a is guided displaceably in the axial direction and has an upper end to which the cam 57a of the camshaft 57 is coupled. The valve head 56b is joined to a lower end of the valve stem 56a and seats on the intake side valve seat 52 inside the combustion chamber 45. The valve stem 56a has an upper end to which a retainer 62 is mounted by the action of a cotter. Between the cylinder head 32c and the retainer 62, a coiled spring 63 is sandwiched in a compressed state. The coiled spring 63 provides an elastic force that holds the valve head 56b at a close position. The air-fuel mixture is introduced into the combustion chamber 45 by the action of the intake valve 56 that is opened and closed corresponding to a rotation of the camshaft 57.

Here, as illustrated in FIG. 3, inside an imaginary plane that passes a center Ct of the opening of the intake port 48 and is perpendicular to a rotation axis of the camshaft 57, the intake port 48 has a curvature of a lower side contour 48b larger than a curvature of an upper side contour 48a. In addition, an angle α between a first imaginary intersecting plane Pf (as a first intersecting plane) and the imaginary plane PL is configured to be smaller than an angle β between a second intersecting plane Ps (as a second intersecting plane) and the first imaginary intersecting plane Pf. The first imaginary intersecting plane Pf is parallel to the rotation axis of the camshaft 57, is circumscribed to the intake ports 48 from below, and intersects with the imaginary plane PL at a center (cylinder axis C) of the cylinder bore 43. The second imaginary intersecting plane Ps is parallel to the rotation axis of the camshaft 57, passes a center of an inlet opening of the intake port 48, and intersects with the imaginary plane PL at the center of the cylinder bore 43. A maximum displaced amount e between the second imaginary intersecting plane Ps and a neutral axis CL of the intake port 48 is configured to be more than 2 mm.

The exhaust valve 58 includes a valve stem 58a and a valve head 58b. The valve stem 58a is guided displaceably in the axial direction and has an upper end coupled to the rocker arm 61. The valve head 58b is joined to a lower end of the valve stem 58a and seats on the exhaust side valve seat 54 inside the combustion chamber 45. A retainer 64 is mounted to the upper end of the valve stem 58a by the action of a cotter. Between the cylinder head 32c and the retainer 64, a coiled spring 65 is sandwiched in a compressed state. The coiled spring 65 provides an elastic force that holds the valve head 58b at a close position.

In the rocker arm 61, a slipper 61a that keeps contacting the cam 57a when the camshaft 57 rotates is formed. The cam 57a presses a tip end of the rocker arm 61 to the upper end of the valve stem 58a. The rocker arm 61 swings around an axis of the rocker arm shaft 59 corresponding to the rotation of the camshaft 57. The rocker arm 61 causes open and close operations of the exhaust valve 58 corresponding to the rotation of the camshaft 57. Exhaust gas is exhausted from the combustion chamber 45 by the action of the exhaust valve 58 that opens and closes corresponding to the rotation of the camshaft 57.

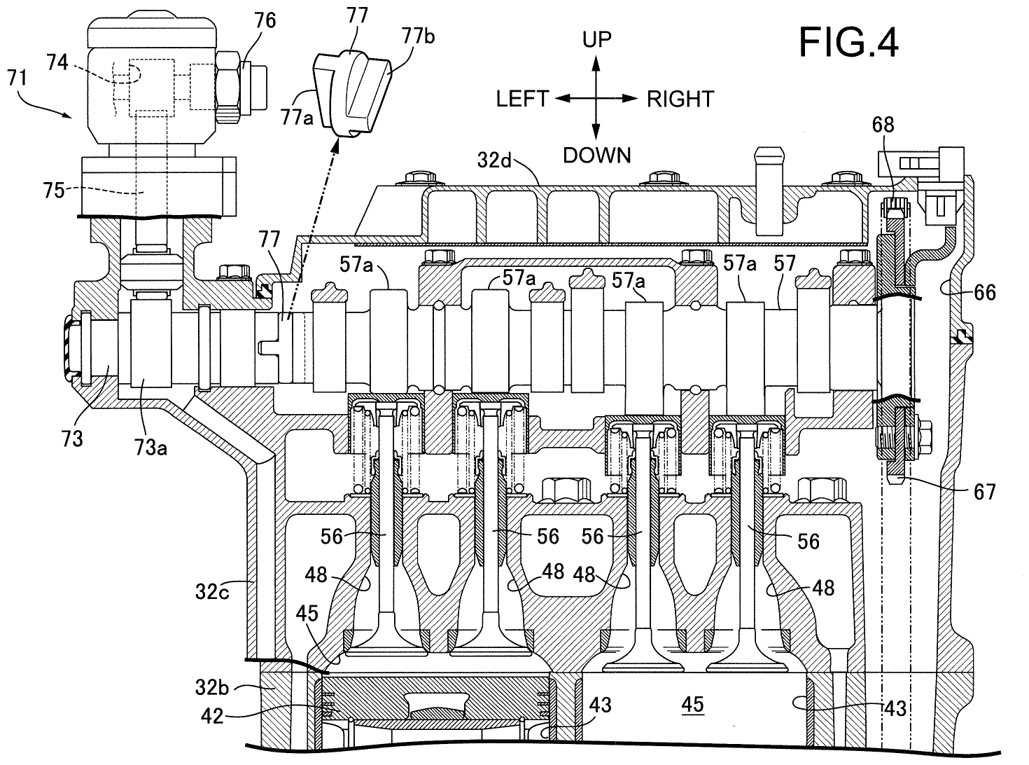

As illustrated in FIG. 4, a cam sprocket 67 arranged inside a cam chain chamber 66 is joined to the camshaft 57. Around the cam sprocket 67, a cam chain 68 is wound. The cam chain 68 is wound around a drive sprocket (not illustrated) joined to the crankshaft 36 inside the cam chain chamber 66. Then, the camshaft 57 is operatively connected with the crankshaft 36. A rotation of the crankshaft 36 is transmitted to the camshaft 57 by the action of the cam chain 68. The intake valve 56 opens and closes the opening of the intake port 48 with respect to the linear reciprocation motions of the piston 42 at a constant opening/closing timing.

As illustrated in FIG. 2, the internal combustion engine 31 includes a high-pressure fuel pump 71 (as a fuel pump) and a fuel injection valve 72. The high-pressure fuel pump 71 is connected to a feed pump (not illustrated) inside a fuel tank and outputs, at a high pressure, the fuel supplied from the feed pump. The fuel injection valve 72 is mounted to the cylinder head 32c, has an injection port 72a facing the combustion chamber 45, and is connected to the high-pressure fuel pump 71. As illustrated in FIG. 4, the high-pressure fuel pump 71 includes a drive shaft 73 coaxially coupled to the camshaft 57. On the drive shaft 73, a cam 73a connected to a plunger 75 that increases and decreases a volume of a pump chamber 74 is formed. The action of the cam 73a causes the plunger 75 to increase and decrease the volume of the pump chamber 74 to generate a pressure. The pressure is adjusted by the action of a solenoid valve 76 that controls a flow rate of the fuel flowing into the pump chamber 74. The high-pressure fuel pump 71 supplies the fuel to the fuel injection valve 72 while varying the pressure within a predetermined range.

Between the drive shaft 73 of the high-pressure fuel pump 71 and the camshaft 57, a joint 77 is arranged. On the joint 77, a first protrusion 77a and a second protrusion 77b are formed. The first protrusion 77a extends on a first diameter line and is fitted to a groove of one end of the drive shaft 73. The second protrusion 77b extends on a second diameter line displaced by an angle of 180 degrees around the axis from the first diameter line and is fitted to a groove of one end of the camshaft 57. Then, while a displacement between mutual axes of the drive shaft 73 and the camshaft 57 is permitted, the rotation of the camshaft 57 is transmitted to the drive shaft 73.

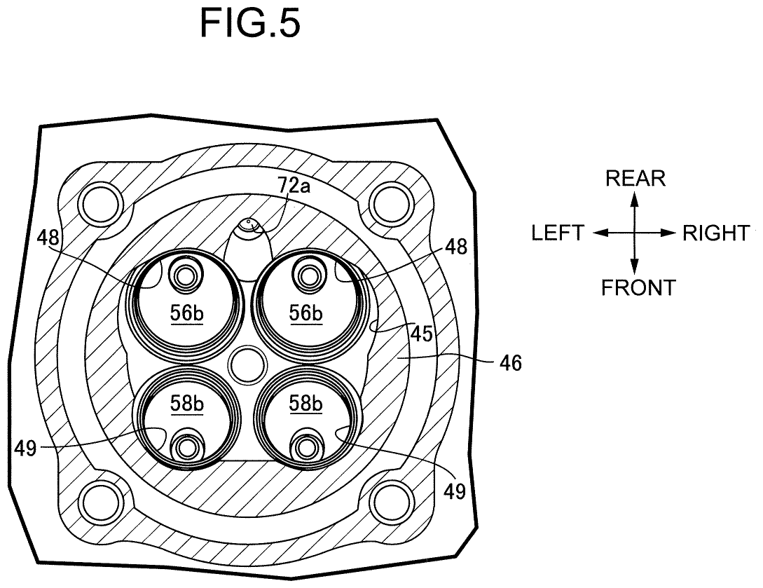

As illustrated in FIG. 5, the injection port 72a of the fuel injection valve 72 faces the combustion chamber 45 at a position between the opening of the intake port 48 and the gasket surface 46. As illustrated in FIG. 2, the fuel injection valve 72 has an axis intersecting with the imaginary plane PL including the gasket surface 46 at an angle smaller than an inclined angle of the intake port 48. Here, the inclined angle of the intake port 48 corresponds to the angle measured at a position at which the intake side valve seat 52 and a bottom wall of the intake port 48 are connected, with respect to the imaginary plane PL. The fuel injection valve 72 injects the fuel inside the combustion chamber 45 based on the high pressure generated with the high-pressure fuel pump 71. The air-fuel mixture is generated corresponding to the injection of the fuel inside the combustion chamber 45.

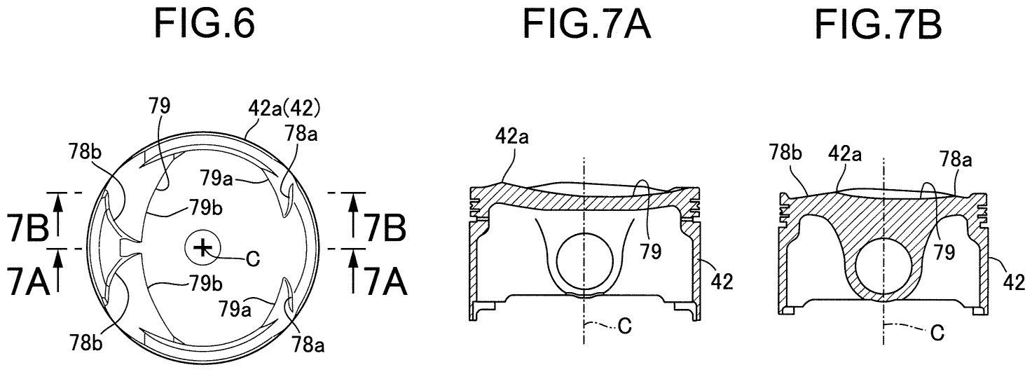

As illustrated in FIG. 6 and FIGS. 7A and 7B, in the top surface 42a of the piston 42, two intake valve recesses 78a, two exhaust valve recesses 78b, and one depression 79 are formed. The two intake valve recesses 78a are opposed to the respective openings of the intake ports 48. Two exhaust valve recesses 78b are opposed to the respective openings of the exhaust ports 49. The depression 79 expands across the two intake valve recesses 78a and the two exhaust valve recesses 78b up to an outer periphery area and is depressed in a spherical surface shape. The individual intake valve recesses 78a are defined by a circular shape corresponding to a projected image of the valve head 56b and are formed to have planes gradually receding from the ceiling surface 47 of the combustion chamber 45 in going toward an outer periphery. The individual exhaust valve recesses 78b are defined by a circular shape corresponding to a projected image of the valve head 58b and are formed to have planes gradually receding from the ceiling surface 47 of the combustion chamber 45 in going toward an outer periphery. The intake valve recesses 78a and the exhaust valve recesses 78b have a function to avoid an interference between the piston 42 and the intake valve 56 and exhaust valve 58 at a top dead center.

The depression 79 is arranged to be biased to the intake valve recess 78a side with respect to the exhaust valve recess 78b. Therefore, the depression 79 has the deepest portion positioned on the fuel injection valve 72 side with respect to the center axis (cylinder axis C) of the piston 42. The depression 79 includes outer edges 79a and outer edges 79b. The outer edges 79a partition the intake valve recesses 78a along a circular arc of a first curvature radius. The outer edges 79b partition the exhaust valve recesses 78b along a circular arc of a second curvature radius larger than the first curvature radius.

Next, the operation of this embodiment are described. During operation of the internal combustion engine 31, in the combustion chamber 45, an intake stroke, a compression stroke, a combustion stroke and an exhaust stroke are repeated. At the intake stroke, in the state where the exhaust valve 58 is closed, the intake valve 56 is opened. The piston 42 moves down corresponding to the rotation of the crankshaft 36. A volume of the combustion chamber 45 increases while the air is introduced into the combustion chamber 45 from the intake port 48. The fuel is injected to the flowing air from the fuel injection valve 72. Inside the combustion chamber 45, the air-fuel mixture is generated. To the fuel injection valve 72, a liquid fuel is supplied from the high-pressure fuel pump 71 under high pressure. For generating the pressure, a driving power is transmitted to the high-pressure fuel pump 71 from the camshaft 57.

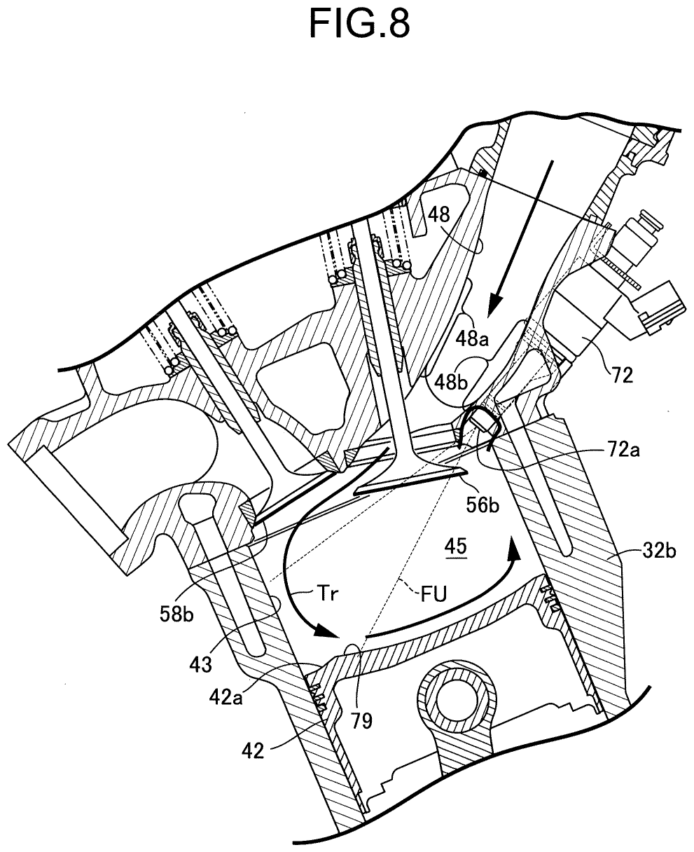

As illustrated in FIG. 8, the air is laterally introduced into the combustion chamber 45, based on the shape of the intake port 48. Inside the combustion chamber 45, a tumble flow (whirl in the vertical direction) Tr is formed. An injected fuel FU is properly caught in the tumble flow Tr. Attachment of the injected fuel FU to a wall surface of the cylinder bore 43 can be reduced. The formation of the tumble flow Tr contributes to improving a fuel efficiency and the output.

The air flowing from the intake port 48 moves down toward the piston 42 along the wall surface of the cylinder bore 43 on an extension of the intake port 48 to be guided to the depression 79 of the top surface 42a, so as to cross the top surface 42a of the piston 42. Since the depression 79 is formed in the top surface 42a of the piston 42, collision and decay of the tumble flow Tr are suppressed. Inside the combustion chamber 45, the tumble flow Tr can be properly formed.

At the compression stroke, in the state where the intake valve 56 and the exhaust valve 58 are closed, the piston 42 moves up corresponding to the rotation of the crankshaft 36. The volume of the combustion chamber 45 is decreased to compress the air-fuel mixture inside the combustion chamber 45.

At the combustion stroke, in the state where the intake valve 56 and the exhaust valve 58 are closed, the air-fuel mixture compressed inside the combustion chamber 45 is ignited. The air-fuel mixture expands in response to the ignition. The volume of the combustion chamber 45 increases corresponding to the expansion of the air-fuel mixture to cause the piston 42 to move down. The driving power is given to the crankshaft 36 corresponding to the moving down of the piston 42.

At the exhaust stroke, in the state where the intake valve 56 is closed, the exhaust valve 58 is opened. The piston 42 moves up corresponding to the rotation of the crankshaft 36. The volume of the combustion chamber 45 is decreased to discharge the exhaust gas after the combustion from the exhaust port 49.

In the internal combustion engine 31 according to this embodiment, the intake port 48 is curved to bulge toward the imaginary plane PL. Therefore, an inertia force is laterally given to the airflow flowing from the intake port 48 into the combustion chamber 45. The air properly and laterally flows into the combustion chamber 45 from the intake port 48. Inside the combustion chamber 45, the tumble flow Tr is ensured. In particular, since the intake port 48 has a curvature of the lower side contour 48b larger than a curvature of the upper side contour 48a inside the imaginary plane that passes the center Ct of the opening of the intake port 48 and is perpendicular to a rotation axis of the camshaft 57, the inertia force is laterally given to the airflow flowing from the intake port 48 into the combustion chamber 45. The air properly and laterally flows into the combustion chamber 45 from the intake port 48. Inside the combustion chamber 45, the tumble flow Tr is properly formed. Evaporation of the fuel spray is promoted.

In addition, the intake port 48 is formed of the intake side valve seat 52 and the intake passage 53. The intake side valve seat 52 is fixed to the cylinder head 32c in the opening of the intake port 48 and receives the valve head 56b of the intake valve 56. The intake passage 53 is defined in the cylinder head 32c and connected to the intake side valve seat 52 from the lateral direction along the imaginary plane PL. In the intake port 48, since the intake passage 53 is laterally connected to the intake side valve seat 52, the air properly and laterally flows into the combustion chamber 45. Inside the combustion chamber 45, the tumble flow Tr is properly formed.

In the internal combustion engine 31 according to this embodiment, the intake side valve seat 52 is formed to be thinner than the exhaust side valve seat 54. Therefore, the lateral flow is not blocked by the intake side valve seat 52. The air properly and laterally flows into the combustion chamber 45. Inside the combustion chamber 45, the tumble flow Tr is properly formed.

Furthermore, in the internal combustion engine 31, the angle α between the first imaginary intersecting plane Pf and the imaginary plane PL is configured to be smaller than the angle β between the second imaginary intersecting plane Ps and the first imaginary intersecting plane Pf. The first imaginary intersecting plane Pf is parallel to the rotation axis of the camshaft 57, is circumscribed to the intake ports 48 from below, and intersects with the imaginary plane PL at the center (cylinder axis C) of the cylinder bore 43. The second intersecting plane Ps is parallel to the rotation axis of the camshaft 57, passes the center of the inlet opening of the intake port 48, and intersects with the imaginary plane PL at the center of the cylinder bore 43. The first imaginary intersecting plane Pf specifies a standing angle of the intake port 48 with respect to the imaginary plane PL including the gasket surface 46. When the angle β of the second imaginary intersecting plane Ps with respect to the first imaginary intersecting plane Pf is increased, a degree of bending of the intake port 48 is increased. The more increased the degree of bending is, the larger inertia force is laterally given to the airflow flowing from the intake port 48 into the combustion chamber 45. Inside the combustion chamber 45, the tumble flow Tr is properly formed. The evaporation of the fuel spray is promoted. Moreover, the more increased the maximum displaced amount e between the second imaginary intersecting plane Ps and the neutral axis CL of the intake port 48 is, the more increased the degree of bending of the intake port 48 becomes. The more increased the degree of bending is, the larger inertia force is laterally given to the airflow flowing from the intake port 48 into the combustion chamber 45. Inside the combustion chamber 45, the tumble flow Tr is properly formed. The evaporation of the fuel spray is promoted.

In this embodiment, the high-pressure fuel pump 71 is connected to the fuel injection valve 72, and supplies the fuel to the fuel injection valve 72 while varying the pressure within a predetermined range. Even when a flow speed of the air to be supplied to the internal combustion engine 31 corresponding to a throttle of a throttle valve is decreased, the pressure supplied from the high-pressure fuel pump 71 to the fuel injection valve 72 corresponding to the decrease of the flow speed is decreased. Thus, the attachment of the injected fuel FU to the wall surface of the cylinder bore 43 is further reduced. The fuel efficiency and the output are further improved.

The intake valve 56 is coupled to the camshaft 57, which is operatively connected with the crankshaft 36, and opens and closes the opening of the intake port 48 with respect to the linear reciprocation motions of the piston 42 at the constant opening/closing timing. Since the intake valve 56 ensures the constant opening/closing timing with respect to the linear reciprocation motions of the piston 42, an inflow amount of the air to the volume of the combustion chamber 45 can be maintained at a determined flow rate. The swirling effect of the tumble flow Tr is stabilized. The fuel efficiency and the output are further improved. Moreover, since an operation timing of the high-pressure fuel pump 71 is involved with the rotation of the camshaft 57, the fuel injection is involved with the opening/closing timing of the intake valve 56. The swirling effect of the tumble flow Tr is stabilized. The fuel efficiency and the output are further improved.

What is claimed is:

1. An in-cylinder injection engine comprising:
a cylinder block that defines a cylinder bore and includes a seating face, the cylinder bore guiding linear reciprocation motions of a piston, the seating face surrounding an opening of the cylinder bore;
a cylinder head that includes a gasket surface stacked on the seating face of the cylinder block and defines a combustion chamber between the piston and a ceiling surface gradually receding from an imaginary plane including the gasket surface in going toward a center of the cylinder head;
two intake ports disposed side by side and opened in the ceiling surface of the cylinder head;
two exhaust ports disposed side by side and opened in the ceiling surface of the cylinder head; and
a fuel injection valve mounted to the cylinder head and having an injection port facing the combustion chamber at a position between an opening of the intake port and the gasket surface,
wherein the intake port is formed to have a shape of introducing an airflow laterally into the combustion chamber along the imaginary plane.

2. The in-cylinder injection engine according to claim 1, wherein
the intake port is curved to bulge toward the imaginary plane.

3. The in-cylinder injection engine according to claim 2, wherein
the intake port is formed of an intake side valve seat and an intake passage, the intake side valve seat being fixed to the cylinder head in the opening of the intake port and receiving an intake valve, the intake passage being defined in the cylinder head to be connected to the intake side valve seat from a lateral direction along the imaginary plane.

4. The in-cylinder injection engine according to claim 3, further comprising
an exhaust side valve seat fixed to the cylinder head in an opening of the exhaust port and receiving an exhaust valve,
wherein the intake side valve seat is formed to be thinner than the exhaust side valve seat.

5. The in-cylinder injection engine according to claim 1, wherein
formed in a top surface of the piston are two intake valve recesses opposed to the respective openings of the intake ports, two exhaust valve recesses opposed to the respective openings of the exhaust ports, and one depression expanding across the two intake valve recesses and the two exhaust valve recesses up to an outer periphery area, the one depression being depressed in a spherical surface shape.

6. The in-cylinder injection engine according to claim 1, further comprising a high-pressure fuel pump connected to the fuel injection valve, the high-pressure fuel pump supplying fuel to the fuel injection valve while varying pressure within a predetermined range.

7. The in-cylinder injection engine according to claim 1, further comprising an intake valve coupled to a camshaft that is operatively connected with a crankshaft, the intake valve opening and closing the opening of the intake port with respect to the linear reciprocation motions of the piston at a constant opening/closing timing.

8. The in-cylinder injection engine according to claim 7, further comprising a fuel pump that includes a drive shaft coaxially coupled to the camshaft and generates pressure corresponding to rotation of the camshaft.

9. The in-cylinder injection engine according to claim 1, further comprising an intake valve coupled to a camshaft that is operatively connected with a crankshaft, the intake valve opening and closing the opening of the intake port,
wherein the intake port is curved to bulge toward the imaginary plane, and
the intake port has a curvature of a lower side contour larger than a curvature of an upper side contour inside an another imaginary plane that passes a center of the opening and is perpendicular to a rotation axis of the camshaft.

10. The in-cylinder injection engine according to claim 1, further comprising an intake valve coupled to a camshaft that is operatively connected with a crankshaft, the intake valve opening and closing the opening of the intake port,
wherein the intake port is curved to bulge toward the imaginary plane, and
an angle between a first intersecting plane and the imaginary plane is configured to be smaller than an angle between a second intersecting plane and the first intersecting plane, the first intersecting plane being parallel to a rotation axis of the camshaft and circumscribed to the intake port from below, the first intersecting plane intersecting with the imaginary plane at a center of the cylinder bore, the second intersecting plane being parallel to the rotation axis of the camshaft and passing a center of an inlet opening of the intake port, and the second intersecting plane intersecting with the imaginary plane at the center of the cylinder bore.

11. The in-cylinder injection engine according to claim 1, further comprising an intake valve coupled to a camshaft that is operatively connected with a crankshaft, the intake valve opening and closing the opening of the intake port,
wherein a maximum displaced amount between an intersecting plane and a neutral axis of the intake port is configured to be more than 2 mm, the intersecting plane being parallel to a rotation axis of the camshaft, the intersecting plane passing a center of an inlet opening of the intake port, and the intersecting plane intersecting with the imaginary plane at a center of the cylinder bore.
